(19) United States
(12) Patent Application Publication
(10) Pub. No.: US 2022/0398506 A1
(43) Pub. Date: Dec. 15, 2022

(54) Systems and Methods for Implicit Rate-Constrained Optimization of Non-Decomposable Objectives

(71) Applicant: Google LLC, Mountain View, CA (US)

(72) Inventors: Abhishek Kumar, Milpitas, CA (US); Harikrishna Narasimhan, Sunnyvale, CA (US); Andrew Steere Cotter, Narragansett, RI (US)

(21) Appl. No.: 17/837,398

(22) Filed: Jun. 10, 2022

Related U.S. Application Data
(60) Provisional application No. 63/209,011, filed on Jun. 10, 2021.

(51) Int. Cl. G06N 20/20

(52) U.S. Cl. CPC G06N 20/20

(57) ABSTRACT

A computer-implemented method for optimizing machine-learned models by non-decomposable objectives with improved performance includes obtaining data indicative of a plurality of machine-learned model parameters and at least one threshold comprising a machine-learned model; initializing an initial plurality of machine-learned model parameters and an initial at least one threshold such that the initial plurality of machine-learned model parameters and the initial at least one threshold satisfy a constraint function; determining a gradient of an objective function with respect to the plurality of machine-learned model parameters at a current optimization step based at least in part on an implicit function of the at least one threshold as a function of the plurality of machine-learned model parameters; and updating the plurality of machine-learned model parameters and the at least one threshold based at least in part on the gradient.

### RELATED APPLICATIONS

This application claims priority to and the benefit of U.S. Provisional Patent Application No. 63/209,011, filed Jun. 10, 2021. U.S. Provisional Patent Application No. 63/209,011 is hereby incorporated by reference in its entirety.

### FIELD

The present disclosure relates generally to optimization of machine-learned models, such as optimization algorithms for machine-learned models. More particularly, the present disclosure relates to systems and methods for implicit rate-constrained optimization of non-decomposable objectives.

### BACKGROUND

In many modern machine learning applications, the performance of a model is evaluated using metrics that are complex and nuanced. For example, in retrieval systems, it is common to evaluate a scoring model based on the area under the precision-recall curve, or the ROC curve, or based on its precision at a certain recall value. Similarly, in many medical diagnostic applications, a model is required to yield low false positive rates while restricting its false negatives rate to be within an allowed limit, and in machine learning fairness applications one might be interested in imposing the “80% rule”, which requires a positive prediction rate of at least 80% on the minority class. Many of these problems cannot be solved by minimizing a standard classification loss.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for optimizing machine-learned models by non-decomposable objectives with improved performance. The computer-implemented method includes obtaining, by a computing system including one or more computing devices, data indicative of a plurality of machine-learned model parameters and at least one threshold composing a machine-learned model. The computer-implemented method includes initializing, by the computing system, an initial plurality of machine-learned model parameters and an initial at least one threshold such that the initial plurality of machine-learned model parameters and the initial at least one threshold satisfy a constraint function. The computer-implemented method includes determining, by the computing system, a gradient of an objective function with respect to the plurality of machine-learned model parameters at a current optimization step based at least in part on an implicit function of the at least one threshold as a function of the plurality of machine-learned model parameters. The computer-implemented method includes updating, by the computing system, the plurality of machine-learned model parameters and the at least one threshold based at least in part on the gradient.

Another example aspect of the present disclosure is directed to a computing system for optimizing machine-learned models by non-decomposable objectives with improved performance. The computer includes one or more processors and one or more computer-readable memory devices storing instructions that, when implemented, cause the one or more processors to perform operations. The operations include obtaining data indicative of a plurality of machine-learned model parameters and at least one threshold composing a machine-learned model. The operations include initializing an initial plurality of machine-learned model parameters and an initial at least one threshold such that the initial plurality of machine-learned model parameters and the initial at least one threshold satisfy a constraint function. The operations include determining a gradient of an objective function with respect to the plurality of machine-learned model parameters at a current optimization step based at least in part on an implicit function of the at least one threshold as a function of the plurality of machine-learned model parameters. The operations include updating the plurality of machine-learned model parameters and the at least one threshold based at least in part on the gradient.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing device according to example embodiments of the present disclosure.

FIG. 1C depicts a block diagram of an example computing device according to example embodiments of the present disclosure.

FIG. 2 depicts an example algorithm for optimizing machine-learned models according to example embodiments of the present disclosure.

FIG. 3 depicts a flow chart diagram of an example method to perform optimization of machine-learned models according to example embodiments of the present disclosure.

Reference numerals that are repeated across plural figures are intended to identify the same features in various implementations.

### DETAILED DESCRIPTION

Generally, the present disclosure is directed to optimization of machine-learned models. One popular family of constrained optimization problems arising in machine learning involves optimizing a non-decomposable evaluation metric with a certain thresholded form, while constraining another metric of interest. Examples of such problems include optimizing false negative rate at a fixed false positive rate, optimizing precision at a fixed recall, optimizing the area under the precision-recall or ROC curves, etc. The above problems cannot be directly solved by minimizing a standard classification loss. In fact, minimizing a standard classification loss for these problems may result in inferior model performance. Moreover, many of the metrics that are used in these problems have a non-decomposable structure. For instance, the metrics cannot be expressed directly in terms of an average over individual data points, making them hard to optimize using standard optimization tools.

To solve these problems, example aspects of the present disclosure formulate a rate-constrained optimization that expresses the threshold parameter(s) as a function of the model parameters via the Implicit Function theorem. The resulting optimization problem can be solved using standard gradient based methods. Systems and methods according to example aspects of the present disclosure demonstrate effectiveness over some existing approaches for these problems. In particular, example aspects of the present disclosure are directed to a popular family of non-decomposable objectives that have a certain thresholded form. This includes metrics like false-negative rate at a fixed false-positive rate, precision at a fixed recall, precision@K, AUC-PR, and AUC-ROC, as well as threshold-based fairness metrics. The task of optimizing these metrics can naturally be written as a constrained optimization problem seeking to optimize a quantity such as the model's precision or false positive rate at one or more thresholds, subject to the model satisfying a set of rate constraints at those thresholds. One existing approach for solving such rate-constrained problems has been to relax the constraints with surrogate losses, and formulate an equivalent Lagrangian-based primal-dual problem. Other approaches have improved upon this approach by using the surrogate relaxations only for the primal updates, but not the dual.

In particular, example aspects of the present disclosure provide for systems and methods for optimizing machine-learned models by non-decomposable objectives with improved performance. For instance, the methods described herein may be implemented on a computing system including one or more computing devices. As another example, a computing system can include one or more processors and one or more memory devices storing computer-readable instructions that, when implemented, cause the one or more processors to perform operations for implementing the methods according to example aspects of the present disclosure.

A computer-implemented method can include obtaining (e.g., by a computing system comprising one or more computing devices) data indicative of a plurality of machine-learned model parameters and at least one threshold defining a machine-learned model. For instance, the data may be indicative of a parameter distribution for the machine-learned model.

Additionally, the computer-implemented method can include initializing (e.g., by the computing system) an initial plurality of machine-learned model parameters and an initial at least one threshold such that the initial plurality of machine-learned model parameters and the initial at least one threshold satisfy a constraint function. For instance, in some implementations, initializing the initial plurality of machine-learned model parameters and the initial at least one threshold can include sampling (e.g., by the computing system) the initial plurality of machine-learned model parameters and the initial at least one threshold from a parameter distribution representative of the machine-learned model parameters. In some implementations, initial values of the model parameters and/or threshold(s) may be provided directly (e.g., at the time they are obtained).

Additionally, the computer-implemented method can include determining (e.g., by the computing system) a gradient of an objective function with respect to the plurality of machine-learned model parameters at a current optimization step based at least in part on an implicit function of the at least one threshold as a function of the plurality of machine-learned model parameters. For instance, the use of the implicit function theorem as described herein provides for the thresholds to be represented as an implicit function of some or all of the model parameters. This implicit function may not be directly known or computed. However, its gradient can be used to optimize the model without requiring the formulation of an equivalent (e.g., Lagrangian-based primal-dual) problem.

For instance, in some implementations, determining the gradient can include determining(e.g., by the computing system) a derivative of the implicit function with respect to the plurality of model parameters based at least in part on a derivative of the constraint function with respect to the plurality of model parameters. Additionally, determining the gradient can include determining (e.g., by the computing system) the gradient based at least in part on the derivative of the implicit function. For instance, the derivative of the implicit function can include the derivative of the constraint function divided by a partial derivative of the constraint function with respect to the at least one threshold. Additionally, the gradient can include a derivative of the objective function with respect to the plurality of model parameters and the multiplication of the derivative of the implicit function with a partial derivative of the objective function with respect to the at least one threshold.

Furthermore, in some implementations, the at least one threshold can include a plurality of thresholds. Additionally, the gradient can include a derivative of the objective function with respect to the plurality of model parameters and the sum of the ratios of the partial derivatives of the objective function and the constraint function with respect to each threshold of the plurality of thresholds multiplied by the constraint function of the threshold.

Additionally, the computer-implemented method can include updating (e.g., by the computing system) the plurality of machine-learned model parameters and the at least one threshold based at least in part on the gradient. For instance, the model may be updated over one or more iterations. A value at a previous iteration (e.g., the initialized values on the first iteration) may be modified by a delta (e.g., a parameter delta) for the current iteration based at least in part on the gradient. For instance, in some implementations, updating the plurality of machine-learned model parameters can include adjusting values of the plurality of machine-learned model parameters at a previous optimization step based at least in part on the gradient. Additionally and/or alternatively, in some implementations, updating the at least one threshold can include adjusting values of the at least one threshold at a previous optimization step based at least in part on an inner product of the derivative of the implicit function and a parameter delta of the plurality of machine-learned model parameters.

In some implementations, updating the at least one threshold can include, at regular optimization steps, setting the at least one threshold such that the at least one threshold satisfies the constraint function for the plurality of machine-learned model parameters at the regular optimization steps. For instance, the thresholds may be updated based on an approximation of the parameter delta for improved computation feasibility. However, this may introduce slight errors over several iterations. The thresholds may be updated normally over most iterations such that the gradient is accurate, and every few iterations the thresholds may be set (e.g., recomputed) to satisfy the constraints based on the current values of the model parameters. In this way, the iterative error is somewhat mitigated.

In some implementations, the objective function and the constraint function are selected for at least one of the precision at fixed recall metric, the FNR at fixed FPR metric, the precision at k metric, the AUC-PR metric, the AUC-ROC metric, or the fairness criterion metric. These example metrics are discussed further below. For instance, each of the example metrics can specify a particular format for the objective function and the constraint function, which are given by f and g.

In some implementations, at least one of the objective function or the constraint function is a smooth differentiable surrogate of the at least one of the objective function or the constraint function. For instance, in some implementations, the smooth differentiable surrogate can be or can include at least one of a sigmoid function or a softplus function. The use of a smooth differentiable surrogate can be useful for cases where the objectives and constraints are non-smooth, thereby complicating gradient-based optimization, by providing a smooth differentiable substitute which may be used with gradient-based optimization while maintaining desirable performance.

In some implementations, the computing system can implement a machine-learned model developer tool or optimization service to optimize a machine-learned model from another service or computing system. For instance, in some implementations, obtaining the data indicative of the plurality of machine-learned model parameters and the at least one threshold comprising the machine-learned model can receiving, by the computing system, the data from a second computing system, such as a computing system holding a machine-learned model to be optimized. Additionally, in some implementations, the computer-implemented method further includes, subsequent to updating the plurality of machine-learned model parameters and the at least one threshold based at least in part on the gradient, providing, by the computing system, data indicative of the plurality of machine-learned model parameters and the at least one threshold to the second computing system. For instance, once the model is optimized (e.g., after some amount of iterations) the optimized model can be returned to the second computing system.

In some implementations, the gradient can further include a regularization cost that penalizes, with respect to the plurality of model parameters, the derivative of the constraint function with respect to the at least one threshold. For instance, the regularization cost can encourage the optimization to prefer model parameters for which the constraint function varies smoothly as a function of the threshold. This can provide that the model generalizes better to unseen examples.

In some implementations, the implicit function can be a function of all parameters of a model. In some implementations, the implicit function may be a function of only a subset of the parameters of a model. In these implementations, the subset of parameters may be updated with respect to the gradient, as described herein. The remaining parameters may be updated using a gradient of the objective function (e.g., surrogate of the objective function) with respect to the parameters and thresholds or a gradient from a combination of the objective function (e.g., surrogate of the objective function) and any other suitable loss (e.g., cross-entropy loss).

Example aspects of the present disclosure depart from the prior Lagrangian-based methods and avoid explicitly solving the constrained optimization problem. Instead, the threshold variables are expressed in the optimization problem as an implicit function of the model parameters. The problem is thus re-formulated as an unconstrained optimization over the model parameters. By using the Implicit Function Theorem, it is possible to compute the gradients for the resulting unconstrained objective, despite not knowing the form of the implicit function. These gradients are used to perform gradient-based optimization. Although the Implicit Function Theorem makes a local statement about the existence of the implicit function, which is valid in a small neighborhood around current model parameters, the present disclosure recognizes that it is possible to effectively use the theorem to make local gradient updates towards optimizing the objective. This formulation can be further extended to apply to more complex learning problems, such as query-based ranking, where standard constrained optimization techniques are known to have notable drawbacks.

Example aspects of the present disclosure are discussed for the purposes of illustration with respect to a binary classification setting, with input space X and labels {0,1}. Example aspects of the present disclosure can be extended to multi-class problems. In the binary classification setting, the goal is to learn a scoring model s^{θ}: X→ [symbol] parameterized by θ ∈ [symbol] ^{p} whose scores can be thresholded to make a binary prediction. A scoring model thresholded at t is denoted by sₜ^{θ}(x)=1(s^{θ}(x)>t) ∈{0,1}. In addition, TP(sₜ^{θ}), FP(sₜ^{θ}) and FN(sₜ^{θ}) denote the true positives, false positive and false negatives, respectively, for the thresholded classifier.

For instance, consider constrained optimization problems of the form

$${min}_{θ ∈ {ℝ}^{p}} f ( θ , λ )$$

such that g(θ, λ)=0 where the objective f: [symbol] ^{p}× [symbol] ^{m} maps the model parameters θ∈ [symbol] ^{p} and a set of m thresholds λ∈ [symbol] ^{m} to a real value, and the constraints (e.g., constraint function) g: [symbol] ^{p}× [symbol] ^{m}→ [symbol] ^{m} map (θ, λ) to m real numbers. θ is assumed to stay in the feasible region, ∀θ, ∃λ s.t.g(θ, λ)=0. Several constrained optimization problems of interest in machine learning satisfy this assumption of feasibility. Some popular examples of evaluation metrics are discussed below.

One example evaluation metric is precision at fixed recall. For instance, to maximize the model's precision at the threshold λ∈ [symbol] at which its recall is β, then the following equations may be used:

$$f ( θ , λ ) = - precision ( {s}_{λ}^{θ} ) = - \frac{T P ( {s}_{λ}^{θ} )}{T P ( {s}_{λ}^{θ} ) + F P ( {s}_{λ}^{θ} )} ;$$

$$g ( θ , λ ) = ( {s}_{λ}^{θ} ) - β = \frac{( {s}_{λ}^{θ} )}{( {s}_{λ}^{θ} ) + ( {s}_{λ}^{θ} )} - β .$$

Another example evaluation metric is FNR at fixed FPR. To minimize the model's false negative rate at the threshold λ∈ [symbol] at which its false positive rate is β∈[0,1], then the following equations may be used:

$$f ( θ , λ ) = F N R ( {s}_{λ}^{θ} ) = \frac{F N ( {s}_{λ}^{θ} )}{T N ( {s}_{λ}^{θ} ) + F P ( {s}_{λ}^{θ} )} ;$$

$$g ( θ , λ ) = F P R ( {s}_{λ}^{θ} ) = \frac{F P ( {s}_{λ}^{θ} )}{T P ( {s}_{λ}^{θ} ) + F N ( {s}_{λ}^{θ} )} - β .$$

Another example evaluation metric is precision at k. To maximize the model's precision at the threshold λ∈ at which it achieves a coverage of k, then:

f(θ,λ)=−precision(s_{λ}^{θ});

g(θ,λ)=TP(s_{λ}^{θ})+FP(s_{λ}^{θ})−k.

Another example evaluation metric is AUC-PR. To maximize the area under the Precision-Recall curve, a Riemann approximation to the area is used. The recall range is divided into m equally-spaced values β₁, . . . , βₘ ∈[0,1]. The average precision that the model achieves when thresholded to match each of the target recalls is then evaluation. This can be written as a constrained optimization problem with m thresholds λ₁, . . . , λₘ ∈, and with the objective and constraints set to:

$$f ( θ , λ ) = - \frac{1}{m} {{\sum }^{m}}_{i = 1} precision ( {s}_{{λ}_{i}}^{θ} )$$

$${g}_{i} ( θ , λ ) = recall ( {s}_{{λ}_{i}}^{θ} ) - {β}_{i} , ∀ i ∈ [ m ] .$$

It is additionally possible to similarly compute the “partial” area under the PR curve in any given range of recall (precision) targets by thresholding only at those particular recall (precision) values. This is particularly useful for excluding low recalls (precisions) since the performance of the model at such thresholds is generally less important.

Another example evaluation metric is AUC-ROC. To maximize the (partial) area under the Receiver Operator Characteristic (ROC) curve, a Riemann approximation is applied. For instance, the FPR range is divided into m values β₁, . . . , βₘ. The average TPR at m thresholds λ₁, . . . , λₘ ∈, is then computed and chosen to satisfy the FPR targets:

$$f ( θ , λ ) = - \frac{1}{m} {\sum }_{i = 1}^{m} T P R ( {s}_{{λ}_{i}}^{θ} )$$

$${g}_{i} ( θ , λ ) = F P R ( {s}_{{λ}_{i}}^{θ} ) - {β}_{i} , ∀ i ∈ [ m ] .$$

Another example evaluation metric is fairness criterion. In a typical group fairness application, each example belongs to one of m protected groups, and the goal is to constrain the model to have equitable performance across all groups. One way to enforce this requirement is to introduce a separate threshold) for examples from each group, and to tune them to satisfy the fairness constraints. For example, the popular demographic parity constraint for two (disjoint) groups, which requires equal positive prediction rates for both groups, can be encoded as:

$$g ( θ , λ ) = \frac{1}{{m}_{1}} ( T {P}_{1} ( {s}_{{λ}_{1}}^{θ} ) + F {P}_{1} ( {s}_{{λ}_{1}}^{θ} ) ) - \frac{1}{{m}_{2}} ( T {P}_{2} ( {s}_{{λ}_{2}}^{θ} ) + F {P}_{2} ( {s}_{{λ}_{2}}^{θ} ) ) ,$$

where TP₁, TP₂ are the true positives on examples belonging to group 1 and 2, respectively, FP₁, FP₂ are the false positives for the two groups, and m₁ and m₂ are the number of examples in the two groups.

Assuming that the model does not map two different training examples to same outputs, for fixed model parameters θ, any of the aforementioned rate constraints (e.g., false positive rate, precision, recall, etc.) can be satisfied to any feasible value by tuning thresholds λ₁, . . . , λₘ alone.

All the rate based optimization objectives and constraints discussed above are non-smooth. To make the problem amenable to gradient based optimization, f and g can be replaced with smooth differentiable surrogates \tilde{f} and \tilde{g}. As examples, the surrogates may be sigmoid functions, SoftMax functions, etc. The smooth differentiable surrogates can be optimized, like the original objective and constraint, by:

$${min}_{θ ∈ {ℝ}^{p}} \tilde{f} ( θ , λ ) s . t . \tilde{g} ( θ , λ ) = 0$$

Some existing constrained optimization approaches for solving these problems have formulated a Lagrangian for the problem, and them performed gradient updates to maximize the Lagrangian over the multipliers and minimize it over θ and λ. Example aspects of the present disclosure relate to avoiding explicitly solving the constrained optimization problem by instead formulating an equivalent unconstrained problem in which the threshold λ is expressed as an implicit function of the model parameters θ (within a neighborhood around θ).

This can be accomplished through the use of the implicit function theorem. Suppose the point (θ⁰,λ⁰)∈ [symbol] ^{p+m} satisfies the constraint, i.e.,\tilde{g}(θ⁰,λ⁰)=0. Then it is possible to express the constraint as an implicit function. λ⁰=\tilde{h}(θ⁰) by appealing to the following theorem. Let U be an open subset in [symbol] ^{p}× [symbol] ^{m} and \tilde{g}: U→ [symbol] ^{m} be a Cⁱ map. Let (θ, λ) represent a point in U, with θ∈^{p}, λ∈^{m}. At a point (θ⁰, λ⁰)∈U where \tilde{g}(θ⁰,λ⁰) and the determinant det[∂\tilde{g}ⁱ/∂λ^{j} (θ⁰,λ⁰)] is nonzero, there exists a neighborhood Θ×λ of (θ⁰,λ⁰),2° in U and a unique C¹ function \tilde{h}: Θ→Λ such that in Θ×Λ⊂U⊂ [symbol] ^{p}× [symbol] ^{m}, and \tilde{g}(θ,λ)=0⇔λ=\tilde{h}(θ). For instance, when these conditions are satisfied, then the constraint \tilde{g}, which is a function of both model parameters θ and threshold λ, can be replaced with the implicit function \tilde{h}, which is a function of only the model parameters.

Using this theorem, it is possible to write λ=\tilde{h}(θ) in a neighborhood of θ⁰, which in turn provides for solving the problem as the equivalent unconstrained problem of minimizing \tilde{f}(θ, \tilde{h}(θ)) over this neighborhood. To solve the resulting unconstrained optimization problem, the derivative of \tilde{f}(θ, \tilde{h}(θ)) with respect to θ is determined by

$${∇}_{θ} \tilde{f} ( θ , \tilde{h} ( θ ) ) = {∇}_{θ} \tilde{f} ( θ , λ ) + \frac{\partial \tilde{f} ( θ , λ )}{\partial λ} {∇}_{θ} \tilde{h} ( θ ) .$$

In this equation, the derivative for a scalar λ is used for simplicity. We will further need the derivative of the implicit function \tilde{h}(·). Since \tilde{g}(θ, \tilde{h}(θ))=0 in this neighborhood, then:

$${∇}_{θ} \tilde{g} ( θ , λ ) + \frac{\partial \tilde{g} ( θ , λ )}{\partial λ} {∇}_{θ} \tilde{h} ( θ ) = 0 ⇒ {∇}_{θ} \tilde{h} ( θ ) = - \frac{{∇}_{θ} \tilde{g} ( θ , λ )}{\frac{\partial \tilde{g} ( θ , λ )}{\partial λ}}$$

This gives the derivative of the implicit function, which can be substituted into the optimization equation to get the final gradients for model parameters θ.

Once the gradients with respect to the model parameters have been computed, the model parameters can be updated based at least in part on the gradients, such as by any suitable optimization algorithm (e.g., gradient descent). For instance, having performed the gradient update on θ with:

θ^{t+1}=θ^{t}−η∇_{θ}\tilde{f}(θt,\tilde{h}(θy)),

where η>0 is a step-size parameter, what remains is to update the threshold. Again appealing to the Implicit Function Theorem, in the neighborhood around the current iterate θ^{t}, it is possible to approximate the new threshold as:

$${λ}^{t + 1} = \tilde{h} ( {θ}^{t + 1} ) = \tilde{h} ( {θ}^{t} + Δθ ) \approx \tilde{h} ( {θ}^{t} ) + 〈 {∇}_{θ} \tilde{h} ( {θ}^{t} ) , Δθ 〉 = {λ}^{t} + 〈 {∇}_{θ} \tilde{h} ( {θ}^{t} ) , Δ θ 〉 .$$

In some implementations, a correction step is applied after every τ minibatch iterations that sets the threshold to satisfy the constraint exactly based on k accumulated minibatches to correct for inaccuracies resulting from the approximation made above. Note that for all the metrics described by precision at k, AUC-PR, and/or AUC-ROC, this correction step can be performed efficiently using a straight-forward line search.

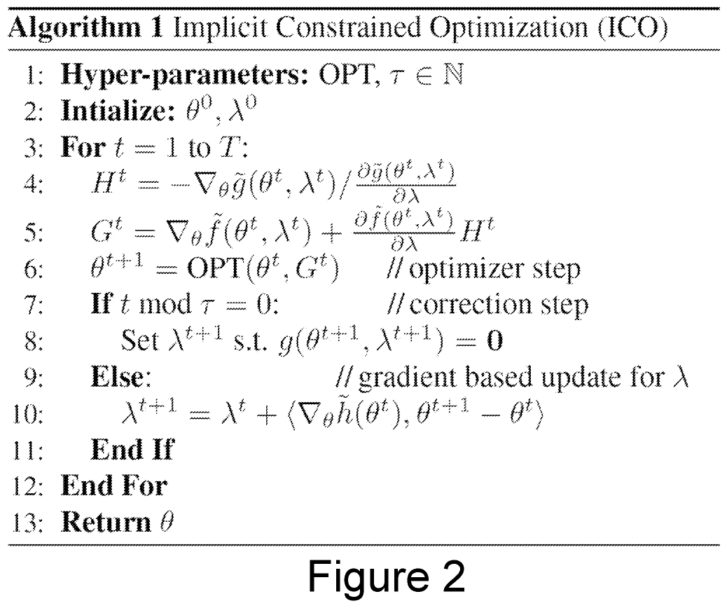

Algorithm 1, which is given in FIG. 2, outlines an example implementation according to example aspects of the present disclosure. In some implementations, it can be effective to use the unrelaxed (and non-smooth) rates, instead of surrogates, for the correction step. For instance, let λ^{t+1}=h(θ^{t+1}), where h computes the threshold at which the unrelaxed g(θ^{t+1}, λ^{t+1})=0.

In some implementations, such as with smaller UCI datasets, a regularizer cost can be imposed on the model parameters. The regularizer cost penalizes∥ d\tilde{g}(θ, λ)/dλ ∥² with respect to θ. This encourages the optimization to prefer model parameters for which the constraint function varies smoothly as a function of the threshold. This can help the model to generalize better on unseen examples.

In some implementations, example aspects of the present disclosure can be useful in optimizing objectives involving multiple constraints. For instance, for optimizing objectives involving multiple constraints (and hence multiple thresholds λ=[λ₁, . . . , λₘ]∈^{m}), such as (partial) PR-AUC or ROC-AUC, one naïve implementation would need multiple gradient computations with respect to θ as follows:

$${∇}_{θ} \tilde{f} ( θ , {h}_{1} ( θ ) , … , {h}_{m} ( {θ}_{m} ) ) = {∇}_{θ} \tilde{f} ( θ , λ ) - {\sum }_{i} \frac{\partial \tilde{f} ( θ , λ )}{\partial {λ}_{i}} \frac{{∇}_{θ} \tilde{g} ( θ , {λ}_{i} )}{\frac{\partial \tilde{f} ( θ , {λ}_{i} )}{\partial {λ}_{i}}}$$

In particular, this implementation may require computation of ∇_{θ}\tilde{f}(θ,λᵢ) for all m constraints. This computation may be costly. However, this cost can be avoided by first computing the partial derivatives of \tilde{f}(θ, λ) and \tilde{g}(θ, λᵢ) with respect to λᵢ which are much cheaper to compute, and then treating their ratios as constants rᵢ. Denoting h(θ)={h₁(θ), . . . , hₘ(θₘ)}, this gradient composition can be rewritten as ∇_{θ}\tilde{f}(θ, h(θ))=∇_{θ}\tilde{f}(θ, λ)−∇_{θ}Σᵢ rᵢ\tilde{g}(θ, λᵢ), which again reduces to just two gradient computations. In some implementations, the gradient based updates for thresholds can also be disabled to avoid computing separate ∇_{θ}(θ, λᵢ) for all i. In this case, it is possible to rely on the correction step of Algorithm 1 every τ minibatches.

The constrained metrics described herein are defined as equality constraints. In some implementations, inequality constraints are handled by searching for thresholds that satisfy the original non-smooth inequality constraints (e.g., during the correction step in Algorithm 1 and/or finally at the end of training). However, the systems and methods described herein can be extended to handle inequality constraints of the form \tilde{f}(θ, λ≤ in a more principled manner. In this case, one can introduce m auxiliary slack variables ζ₁, . . . , ζₘ ∈₊, and rewrite the inequality-constrained problem as one with equality constraints

$${min}_{θ {∈}^{p} , ξ {∈}_{+}^{m}} \tilde{f} ( θ , λ )$$

such that \tilde{g}(θ,λ)+ζ=0. Algorithm 1 can now be applied to solve the re-written problem by treating the model parameters and auxiliary variables (θ,ζ)∈ [symbol] ^{p}× [symbol] ₊^{m} together as the optimization variables, with an additional projection step in the gradient descent procedure to ensure non-negativity of the ζᵢs.

Systems and methods according to example aspects of the present disclosure can be used to optimize for recent group fairness metrics. In some fairness setups, each example belongs to one of m protected groups, and the goal is to constrain the model to have equitable performance across all groups. One way to enforce this requirement is to introduce a threshold λᵢ for examples from group i∈[m], and to then tune the m thresholds to satisfy the fairness constraints. This reliance upon thresholds makes these constraints amenable to optimization with implicit functions. For example, if one wishes to minimize the classification error subject to the 80% rule, which requires the proportion of positive predictions to be at least 80% for each group, one can set this up as an optimization problem of the form given earlier, with the objective f defined as the classification error, and the constraints set to

$${g}_{i} ( θ , λ ) = \frac{1}{{m}_{i}} ( T {P}_{i} ( {s}_{{λ}_{i}}^{θ} ) + F {P}_{i} ( {s}_{{λ}_{i}}^{θ} ) ) - 0 \text{.8} ,$$

where TPᵢ and FPᵢ are the true positives and false positives on examples belonging group i, and mᵢ is the total number of examples in group i. In practice, one can impose more than one constraint per group, as long as for any θ, one can always find thresholds λᵢs for which the constraints are satisfied (which can be the case with popular fairness metrics such as equal opportunity).

Example aspects of the present disclosure have been discussed with reference to binary classification tasks. The extension to multi-class metrics provides for predicting only one label among m labels. As with the binary classification setting, a scoring model s ^{θ}: X→ [symbol] ^{m} that outputs m scores is used, and there is one parameter λᵢ for each class i∈[m]. The parameters λᵢ's can then be used to post-shift the model via a weighted or shifted argmax to predict the final class s_{λ}^{θ}(x)∈arg max_{i∈[m]}(sᵢ^{θ}(x)−λᵢ). Computing the parameters λs so that the resulting classifier satisfies the specified constraints can be performed efficiently. A feasible λ may exist for at least constraints like “coverage”, which require that the model makes a certain percentage of predictions from each class.

Example aspects of the present disclosure can additionally be extended to query-based ranking problems. In the query-based ranking problems, each example contains a query and a list of documents, and the goal is to rank the documents based on the relevance to the query. Popular ranking metrics such as Precision@K or Recall@K seek to measure performance in the top ranked documents. Unfortunately, writing these metrics out as an explicit constrained optimization problem can require one constraint per query, with the number of constraints growing with the size of the training set. Consequently, standard constrained optimization approaches, when applied to optimize these metrics, would need to maintain one Lagrange multiplier for each query, making it impractical to use them with large datasets. In contrast, systems and methods according to example aspects of the present disclosure offer an alternate route which does not require explicitly handling the large number of constraints, through implicit modeling of the per-query thresholds.

Systems and methods according to example aspects of the present disclosure provide a number of technical effects and benefits, including improvements to computing technology. For instance, systems and methods according to example aspects of the present disclosure can perform significantly better than some state-of-the-art constrained optimization solvers in optimizing popular metrics such as FNR at fixed FPR, and the “partial” areas under the ROC and Precision-Recall curves evaluated at a selection range of FPR/recall values. For instance, example aspects of the present disclosure, such as the use of an optimizer with respect to an implicit function of the threshold(s), can provide improved accuracy of optimized models, improved convergence time, more accurate performance at given objectives, etc. Systems and methods according to example aspects of the present disclosure can be particularly effective when used to target extreme values of FPR or recall.

With reference now to the Figures, example embodiments of the present disclosure will be discussed in further detail.

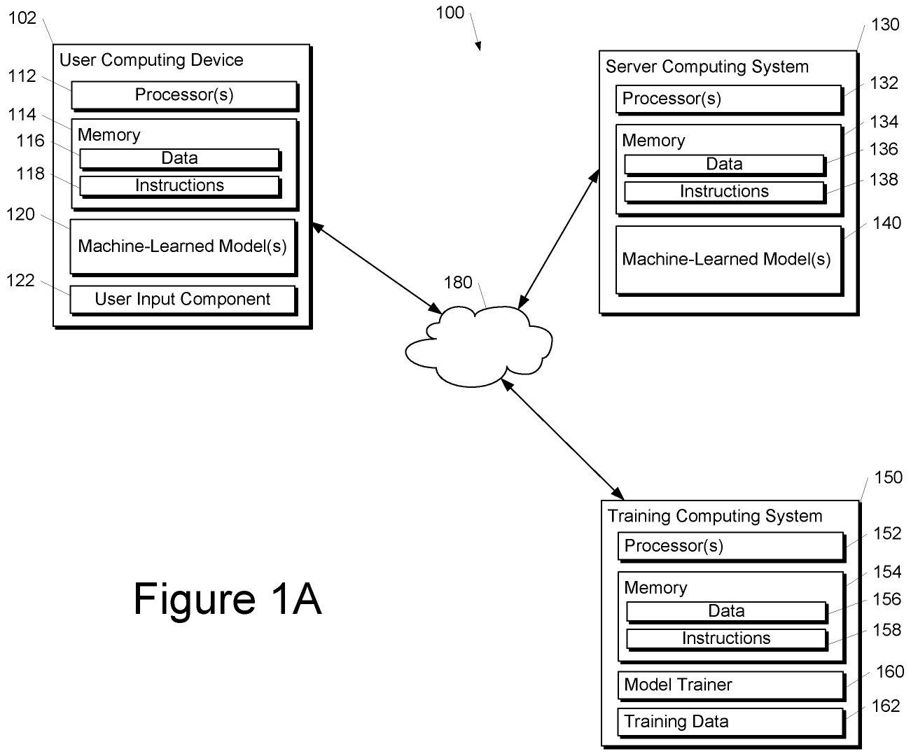

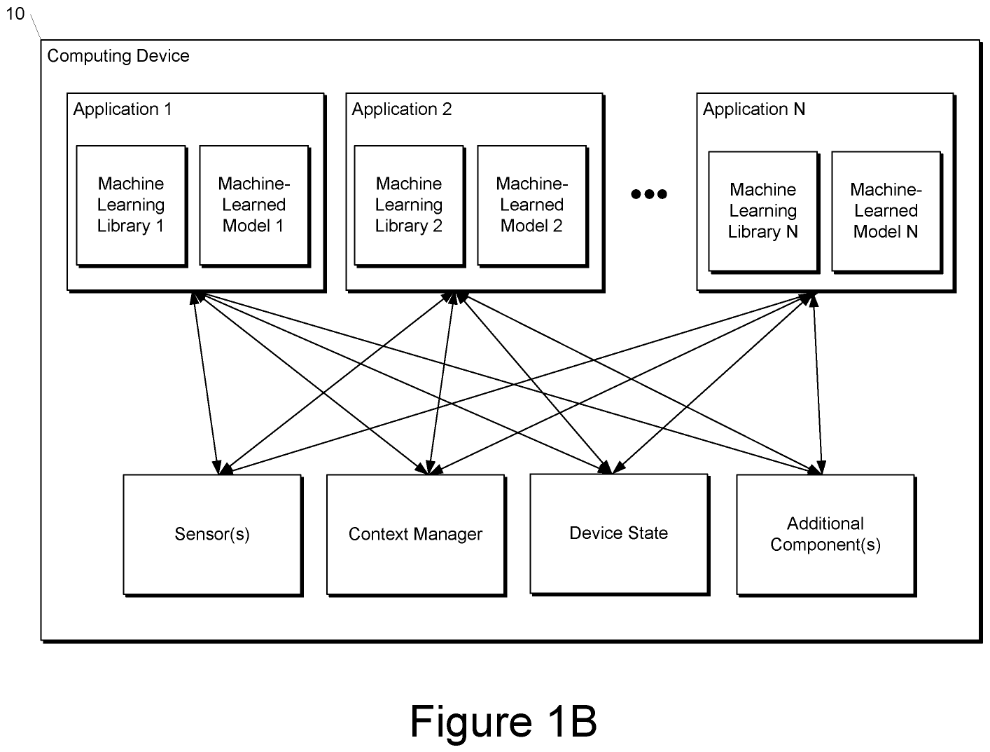

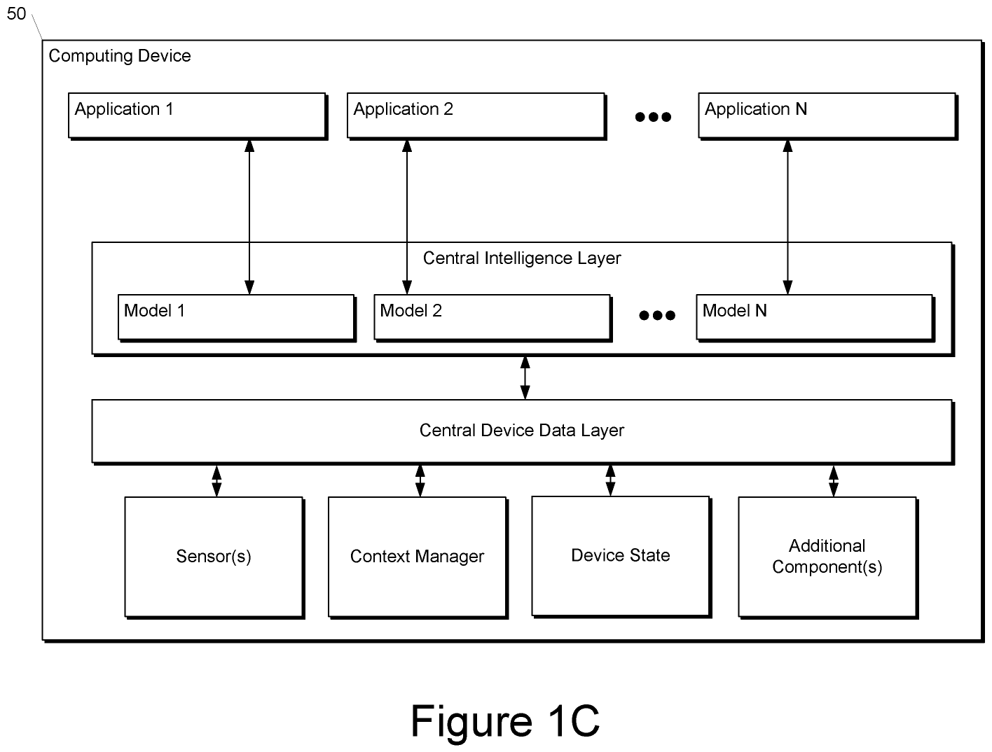

FIG. 1A depicts a block diagram of an example computing system 100 that performs optimization of machine-learned models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel prediction across multiple instances of a machine-learned model).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

Additionally, the training computing system 150 can be configured to optimize the machine-learned model 120 and/or 140. For example, a developer may provide machine-learned models to an optimization service or optimization tool at server computing system 140 and/or training computing system 150 that provides the model parameters for optimization at training computing system 150.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

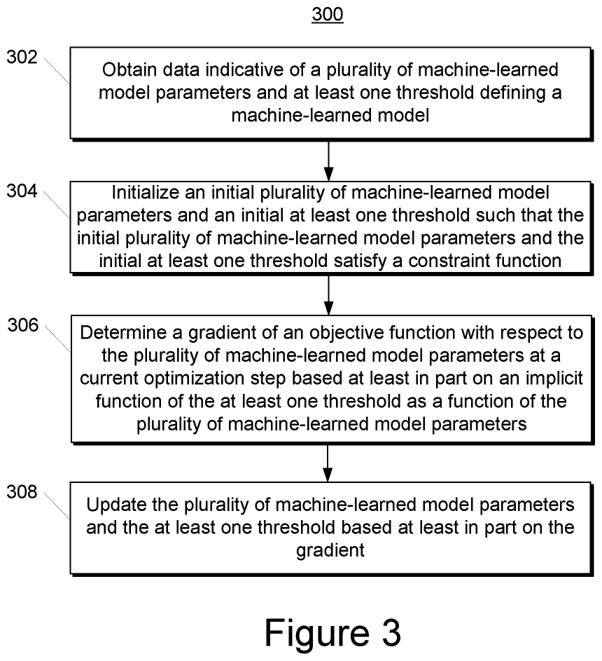

FIG. 3 depicts a flow chart diagram of an example method 300 to perform optimizing machine-learned models by non-decomposable objectives with improved performance according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

The computer-implemented method 300 can include, at 302, obtaining (e.g., by a computing system comprising one or more computing devices) data indicative of a plurality of machine-learned model parameters and at least one threshold defining a machine-learned model. For instance, the data may be indicative of a parameter distribution for the machine-learned model.

Additionally, the computer-implemented method 300 can include, at 304, initializing (e.g., by the computing system) an initial plurality of machine-learned model parameters and an initial at least one threshold such that the initial plurality of machine-learned model parameters and the initial at least one threshold satisfy a constraint function. For instance, in some implementations, initializing the initial plurality of machine-learned model parameters and the initial at least one threshold can include sampling (e.g., by the computing system) the initial plurality of machine-learned model parameters and the initial at least one threshold from a parameter distribution representative of the machine-learned model parameters. In some implementations, initial values of the model parameters and/or threshold(s) may be provided directly (e.g., at the time they are obtained).

Additionally, the computer-implemented method can include, at 306, determining (e.g., by the computing system) a gradient of an objective function with respect to the plurality of machine-learned model parameters at a current optimization step based at least in part on an implicit function of the at least one threshold as a function of the plurality of machine-learned model parameters. For instance, the use of the implicit function theorem as described herein provides for the thresholds to be represented as an implicit function of the model parameters. This implicit function may not be directly known or computed. However, its gradient can be used to optimize the model without requiring the formulation of an equivalent (e.g., Lagrangian-based primal-dual) problem.

For instance, in some implementations, determining the gradient can include determining(e.g., by the computing system) a derivative of the implicit function with respect to the plurality of model parameters based at least in part on a derivative of the constraint function with respect to the plurality of model parameters. Additionally, determining the gradient can include determining (e.g., by the computing system) the gradient based at least in part on the derivative of the implicit function. For instance, the derivative of the implicit function can include the derivative of the constraint function divided by a partial derivative of the constraint function with respect to the at least one threshold. Additionally, the gradient can include a derivative of the objective function with respect to the plurality of model parameters and the multiplication of the derivative of the implicit function with a partial derivative of the objective function with respect to the at least one threshold.

Furthermore, in some implementations, the at least one threshold can include a plurality of thresholds. Additionally, the gradient can include a derivative of the objective function with respect to the plurality of model parameters and the sum of the ratios of the partial derivatives of the objective function and the constraint function with respect to each threshold of the plurality of thresholds multiplied by the constraint function of the threshold.

Additionally, the computer-implemented method can include, at 308, updating (e.g., by the computing system) the plurality of machine-learned model parameters and the at least one threshold based at least in part on the gradient. For instance, the model may be updated over one or more iterations. A value at a previous iteration (e.g., the initialized values on the first iteration) may be modified by a delta (e.g., a parameter delta) for the current iteration based at least in part on the gradient. For instance, in some implementations, updating the plurality of machine-learned model parameters can include adjusting values of the plurality of machine-learned model parameters at a previous optimization step based at least in part on the gradient. Additionally and/or alternatively, in some implementations, updating the at least one threshold can include adjusting values of the at least one threshold at a previous optimization step based at least in part on an inner product of the derivative of the implicit function and a parameter delta of the plurality of machine-learned model parameters.

In some implementations, updating the at least one threshold can include, at regular optimization steps, setting the at least one threshold such that the at least one threshold satisfies the constraint function for the plurality of machine-learned model parameters at the regular optimization steps. For instance, the thresholds may be updated based on an approximation of the parameter delta for improved computation feasibility. However, this may introduce slight errors over several iterations. The thresholds may be updated normally over most iterations such that the gradient is accurate, and every few iterations the thresholds may be set (e.g., recomputed) to satisfy the constraints based on the current values of the model parameters. In this way, the iterative error is somewhat mitigated.

In some implementations, the objective function and the constraint function are selected for at least one of the precision at fixed recall metric, the FNR at fixed FPR metric, the precision at k metric, the AUC-PR metric, the AUC-ROC metric, or the fairness criterion metric. These example metrics are discussed further below. For instance, each of the example metrics can specify a particular format for the objective function and the constraint function, which are given by f and g.

In some implementations, at least one of the objective function or the constraint function is a smooth differentiable surrogate of the at least one of the objective function or the constraint function. For instance, in some implementations, the smooth differentiable surrogate can be or can include at least one of a sigmoid function or a softplus function. The use of a smooth differentiable surrogate can be useful for cases where the objectives and constraints are non-smooth, thereby complicating gradient-based optimization, by providing a smooth differentiable substitute which may be used with gradient-based optimization while maintaining desirable performance.

In some implementations, the computing system can implement a machine-learned model developer tool or optimization service to optimize a machine-learned model from another service or computing system. For instance, in some implementations, obtaining the data indicative of the plurality of machine-learned model parameters and the at least one threshold comprising the machine-learned model can receiving, by the computing system, the data from a second computing system, such as a computing system holding a machine-learned model to be optimized. Additionally, in some implementations, the computer-implemented method further includes, subsequent to updating the plurality of machine-learned model parameters and the at least one threshold based at least in part on the gradient, providing, by the computing system, data indicative of the plurality of machine-learned model parameters and the at least one threshold to the second computing system. For instance, once the model is optimized (e.g., after some amount of iterations) the optimized model can be returned to the second computing system.

In some implementations, the gradient can further include a regularization cost that penalizes, with respect to the plurality of model parameters, the derivative of the constraint function with respect to the at least one threshold. For instance, the regularization cost can encourage the optimization to prefer model parameters for which the constraint function varies smoothly as a function of the threshold. This can provide that the model generalizes better to unseen examples.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for optimizing machine-learned models by non-decomposable objectives with improved performance, the method comprising:
obtaining, by a computing system comprising one or more computing devices, data indicative of a plurality of machine-learned model parameters and at least one threshold comprising a machine-learned model;
initializing, by the computing system, an initial plurality of machine-learned model parameters and an initial at least one threshold such that the initial plurality of machine-learned model parameters and the initial at least one threshold satisfy a constraint function;
determining, by the computing system, a gradient of an objective function with respect to the plurality of machine-learned model parameters at a current optimization step based at least in part on an implicit function of the at least one threshold as a function of the plurality of machine-learned model parameters; and
updating, by the computing system, the plurality of machine-learned model parameters and the at least one threshold based at least in part on the gradient.

2. The computer-implemented method of claim 1, wherein determining the gradient comprises:
determining, by the computing system, a derivative of the implicit function with respect to the plurality of model parameters based at least in part on a derivative of the constraint function with respect to the plurality of model parameters; and
determining, by the computing system, the gradient based at least in part on the derivative of the implicit function.

3. The computer-implemented method of claim 2, wherein the derivative of the implicit function comprises the derivative of the constraint function divided by a partial derivative of the constraint function with respect to the at least one threshold.

4. The computer-implemented method of claim 2, wherein the gradient comprises a derivative of the objective function with respect to the plurality of model parameters and the multiplication of the derivative of the implicit function with a partial derivative of the objective function with respect to the at least one threshold.

5. The computer-implemented method of claim 2, wherein the at least one threshold comprises a plurality of thresholds, and wherein the gradient comprises a derivative of the objective function with respect to the plurality of model parameters and the sum of the ratios of the partial derivatives of the objective function and the constraint function with respect to each threshold of the plurality of thresholds multiplied by the constraint function of the threshold.

6. The computer-implemented method of claim 1, wherein initializing the initial plurality of machine-learned model parameters and the initial at least one threshold comprises sampling, by the computing system, the initial plurality of machine-learned model parameters and the initial at least one threshold from a parameter distribution comprising the machine-learned model parameters.

7. The computer-implemented method of claim 1, wherein updating the plurality of machine-learned model parameters comprises adjusting values of the plurality of machine-learned model parameters at a previous optimization step based at least in part on the gradient.

8. The computer-implemented method of claim 1, wherein updating the at least one threshold comprises adjusting values of the at least one threshold at a previous optimization step based at least in part on an inner product of the derivative of the implicit function and a parameter delta of the plurality of machine-learned model parameters.

9. The computer-implemented method of claim 1, wherein updating the at least one threshold comprises, at regular optimization steps, setting the at least one threshold such that the at least one threshold satisfies the constraint function for the plurality of machine-learned model parameters at the regular optimization steps.

10. The computer-implemented method of claim 1, wherein the gradient comprises a regularization cost that penalizes, with respect to the plurality of model parameters, the derivative of the constraint function with respect to the at least one threshold.

11. The computer-implemented method of claim 1, wherein at least one of the objective function or the constraint function comprises a smooth differentiable surrogate of the at least one of the objective function or the constraint function.

12. The computer-implemented method of claim 11, wherein the smooth differentiable surrogate comprises at least one of a sigmoid function or a softplus function.

13. The computer-implemented method of claim 1, wherein the objective function and the constraint function are selected for at least one of the precision at fixed recall metric, the FNR at fixed FPR metric, the precision at k metric, the AUC-PR metric, the AUC-ROC metric, or the fairness criterion metric.

14. The computer-implemented method of claim 1, wherein:
obtaining the data indicative of the plurality of machine-learned model parameters and the at least one threshold comprising the machine-learned model comprises receiving, by the computing system, the data from a second computing system; and
wherein the computer-implemented method further comprises, subsequent to updating the plurality of machine-learned model parameters and the at least one threshold based at least in part on the gradient, providing, by the computing system, data indicative of the plurality of machine-learned model parameters and the at least one threshold to the second computing system.

15. A computing system for optimizing machine-learned models by non-decomposable objectives with improved performance, the computing system comprising:
one or more processors; and
one or more computer-readable memory devices storing instructions that, when implemented, cause the one or more processors to perform operations, the operations comprising:
obtaining data indicative of a plurality of machine-learned model parameters and at least one threshold comprising a machine-learned model;
initializing an initial plurality of machine-learned model parameters and an initial at least one threshold such that the initial plurality of machine-learned model parameters and the initial at least one threshold satisfy a constraint function;
determining a gradient of an objective function with respect to the plurality of machine-learned model parameters at a current optimization step based at least in part on an implicit function of the at least one threshold as a function of the plurality of machine-learned model parameters; and
updating the plurality of machine-learned model parameters and the at least one threshold based at least in part on the gradient.

16. The computing system of claim 15, wherein at least one of the objective function or the constraint function comprises a smooth differentiable surrogate of the at least one of the objective function or the constraint function.

17. The computing system of claim 15, wherein determining the gradient comprises:
determining, by the computing system, a derivative of the implicit function with respect to the plurality of model parameters based at least in part on a derivative of the constraint function with respect to the plurality of model parameters; and
determining, by the computing system, the gradient based at least in part on the derivative of the implicit function.

18. The computing system of claim 17, wherein the derivative of the implicit function comprises the derivative of the constraint function divided by a partial derivative of the constraint function with respect to the at least one threshold.

19. The computing system of claim 17, wherein the gradient comprises a derivative of the objective function with respect to the plurality of model parameters and the multiplication of the derivative of the implicit function with a partial derivative of the objective function with respect to the at least one threshold.

20. The computing system of claim 17, wherein the at least one threshold comprises a plurality of thresholds, and wherein the gradient comprises a derivative of the objective function with respect to the plurality of model parameters and the sum of the ratios of the partial derivatives of the objective function and the constraint function with respect to each threshold of the plurality of thresholds multiplied by the constraint function of the threshold.
